(19) United States
(12) Patent Application Publication
(10) Pub. No.: US 2020/0381138 A1
(43) Pub. Date: Dec. 3, 2020

(54) TRANSPARENT CONDUCTIVE LAMINATE

(71) Applicant: TEIJIN LIMITED, Osaka-shi, Osaka (JP)

(72) Inventors: Haruhiko ITOH, Osaka-shi (JP); Koichi IMAMURA, Osaka-shi (JP)

(73) Assignee: TEIJIN LIMITED, Osaka-shi, Osaka (JP)

(21) Appl. No.: 16/970,668

(22) PCT Filed: Feb. 19, 2019
(86) PCT No.: PCT/JP2019/006159

§ 371 Date: Aug. 18, 2020

(30) Foreign Application Priority Data
Feb. 20, 2018 (JP) 2018-028061

(51) Int. Cl. H01B 5/14; B32B 7/025; H01B 1/22; B32B 7/023; B22F 1/00

(52) U.S. Cl. CPC H01B 5/14; B32B 7/025; H01B 1/22; B22F 2301/255; B22F 1/0022; B22F 1/0025; B32B 7/023

(57) ABSTRACT

A transparent conductive laminate 100 includes a laminated substrate 50 and a transparent conductive layer 10 laminated on the laminated substrate 50. The laminated substrate 50 includes a transparent substrate 30 and a cured resin layer 20 laminated on the transparent substrate. The transparent conductive layer 10 includes a fibrous conductive material. The laminated substrate has a top peak of a transmission spectrum and a bottom peak of a reflection spectrum in a range of 385 nm to 485 nm, and the laminated substrate does not have a bottom peak of a transmission spectrum and a top peak of a reflection spectrum in a range of 385 nm to 485 nm. The refractive index of the cured resin layer is less than the refractive index of the transparent substrate.

### TECHNICAL FIELD

The present invention relates to a transparent conductive laminate. In particular, the present invention relates to a transparent conductive laminate for flat panel displays, touch panels, solar cells, and the like.

### BACKGROUND

Transparent conductive laminates are used in many applications requiring transparent electrodes, for example, as transparent electrodes for flat panel displays (e.g., liquid crystal displays and plasma displays), touch panels, solar cells, and the like. As a specific material for forming the transparent conductive film of the transparent conductive laminate, a transparent conductive metal oxide, in particular, indium tin oxide (ITO) has been used.

On the other hand, in recent years, it has been proposed to use a fibrous conductive material such as silver nanowires as a specific material for forming a transparent conductive layer of a transparent conductive laminate.

### CITATION LIST

### Patent Literature

[PTL 1] JP-A-2017-082305

### SUMMARY

### Problems to be Solved by the Invention

The present inventors have found a problem that when a transparent conductive layer is formed using a fibrous conductive material such as silver nanowires, it is difficult to achieve both good color tone and transmittance due to surface plasmon resonance inherent to the fibrous conductive material.

In this context, an object of the present invention is to provide a transparent conductive laminate capable of achieving both good color tone and good transmittance.

### Solution to Problems

Means for solving the above problems are as follows.

### Embodiment 1

A transparent conductive laminate comprising a laminated substrate and a transparent conductive layer laminated on the laminated substrate, wherein
the laminated substrate comprises a transparent substrate and a cured resin layer laminated on the transparent substrate,
the laminated substrate has a top peak of transmission spectrum and a bottom peak of reflection spectrum in a range of 385 nm to 485 nm,
the laminated substrate does not have a bottom peak of transmission spectrum and a top peak of reflection spectrum in a. range of 385 nm to 485 nm,
the transparent conductive layer comprises a fibrous conductive material, and
the refractive index of the cured resin layer is less than the refractive index of the transparent substrate.

### Embodiment 2

The transparent conductive laminate according to embodiment 1, wherein the refractive index of the cured resin layer and the refractive index of the transparent substrate are different from each other by 0.05 or more.

### Embodiment 3

The transparent conductive laminate according to embodiment 1 or 2. wherein the cured resin layer is formed of a cured resin and particles dispersed in the cured resin.

### Embodiment 4

The transparent conductive laminate of embodiment 3, wherein the particles are selected from the group consisting of metal oxides, metal nitrides, and metal fluorides.

### Embodiment 5

The transparent conductive laminate of any one of embodiments 1 to 4, wherein, in the range of 650 nm to 850 nm,
the laminated substrate does not have a bottom peak of transmission spectrum, and does not have a top peak of transmission spectrum or has one top peak of transmission spectrum, and/or
the laminated substrate does not have a top peak of reflection spectrum, and does not have a bottom peak of reflection spectrum or has one bottom peak of reflection spectrum.

### Embodiment 6

The transparent conductive laminate according to any one of embodiments 1 to 5, wherein b* value in L*a*b* colorimetric system of the laminated substrate is −0.40 or less.

### Embodiment 7

The transparent conductive laminate according to any one of embodiments 1 to 6, wherein the fibrous conductive material is a silver wire.

### Embodiment 8

The transparent conductive laminate according to any one of embodiments 1 to 7, wherein the total light transmittance is 90% or more.

### Embodiment 9

The transparent conductive laminate of any one of embodiments 1 to 8, wherein the haze value is 1.00% or less.

### Embodiment 10

The transparent conductive laminate according to any one of embodiments 1 to 9, wherein the absolute value of b* value in L*a*b* colorimetric system is 0.80 or less.

### Effect of Invention

The transparent conductive laminate according to the present invention can achieve both good color tone and good transmittance. This also allows the transparent conductive laminate according to the present invention to be used in many applications requiring transparent electrodes such as touch panels.

### BRIEF DESCRIPTION OF THE DRAWINGS

FIG. 1 is a schematic diagram showing an example of the structure of the laminated substrate of the present invention.

FIG. 2 is a diagram showing (a) a transmission spectrum and (b) a reflection spectrum of the transparent substrate and the transparent substrate with a transparent conductive layer used in Reference Example 1.

FIG. 3 is a diagram showing (a) a transmission spectrum and (b) a reflection spectrum of the laminated substrate used in Example 1.

FIG. 4 is a diagram showing (a) a transmission spectrum and (b) a reflection spectrum of the laminated substrate used in Example 2.

FIG. 5 is a diagram showing (a) a transmission spectrum and (b) a reflection spectrum of the laminated substrate used in Comparative Example 1.

FIG. 6 is a diagram showing (a) a transmission spectrum and (b) a reflection spectrum of the laminated substrate used in Comparative Example 2.

FIG. 7 is a diagram showing (a) a transmission spectrum and (b) a reflection spectrum of the transparent substrate and the transparent substrate with a transparent conductive layer used in Reference Example 2.

FIG. 8 is a diagram showing (a) a transmission spectrum and (b) a reflection spectrum of the laminated substrate used in Example 3.

FIG. 9 is a diagram showing (a) a transmission spectrum and (b) a reflection spectrum of the laminated substrate used in Example 4.

FIG. 10 is a diagram showing (a) a transmission spectrum and (b) a reflection spectrum of the laminated substrate used in Example 5.

FIG. 11 is a diagram showing (a) a transmission spectrum and (b) a reflection spectrum of the laminated substrate used in Example 6.

FIG. 12 is a diagram showing (a) a transmission spectrum and (b) a reflection spectrum of the laminated substrate (both sides) used in Example 7.

FIG. 13 is a diagram showing (a) a transmission spectrum and (b) a reflection spectrum of the laminated substrate used in Comparative Example 3.

FIG. 14 is a diagram showing (a) a transmission spectrum and (b) a reflection spectrum of the laminated substrate used in Comparative Example 4.

### DESCRIPTIONS OF EMBODIMENTS

### <Transparent Conductive Laminate>

The transparent conductive laminate of the present invention has a laminated substrate and a transparent conductive layer laminated on the laminated substrate. The laminated substrate has a transparent substrate and a cured resin layer laminated on the transparent substrate, and the transparent conductive layer has a fibrous conductive material.

Thus, examples of the constitutions of the transparent conductive laminate include the following:
Transparent substrate/cured resin layer/transparent conductive layer
Cured resin layer/transparent substrate/cured resin layer/transparent conductive layer
Transparent conductive layer/cured resin layer/transparent substrate/cured resin layer/transparent conductive layer.

Further, the laminated substrate has a top peak of the transmission spectrum and a bottom peak of the reflection spectrum in the range of 385 nm to 485 nm, and the laminated substrate does not have a bottom peak of the transmission spectrum and a top peak of the reflection spectrum in the range of 385 nm to 485 nm. The refractive index of the cured resin layer is smaller than that of the transparent substrate.

By the transparent conductive laminate of the present invention, it is possible to solve the problem which occurs in the case of forming a transparent conductive layer using a fibrous conductive material such as silver nanowires, that is, the problem that it is difficult to achieve both good color tone and transmittance in a transparent conductive laminate having such a transparent conductive layer due to surface plasmon resonance inherent to the fibrous conductive material.

Although not being limited to theory, it is considered that, by using the transparent conductive laminate of the present invention, the change of the color tone due to the surface plasmon resonance of the fibrous conductive material is cancelled by the color tone represented by the transmission spectrum and the reflection spectrum mentioned above, thereby both good color tone and transmittance are achieved.

Thus, the transparent conductive laminate of the present invention may have, for example, a total light transmittance of 90% or more, 91% or more, 92% or more, or 93% or more. This total light transmittance may be 98% or less, 97% or less, 96% or less, 95% or less, or 94% or less.

In the present invention, the total light transmittance is measured according to JIS 17361-1. Specifically, the total light transmittance τₜ (%) is the value represented by the following equation:

τₜ=τ₂/τ₁×100
(τ₁: incident light
τ₂: total light transmitted through the sample)

In addition, the transparent conductive laminate of the present invention may have, for example, a haze value of less than or equal to 1.00%, less than or equal to 0.90%, less than or equal to 0.80%, or less than or equal to 0.70%. The haze value may be 0.10% or more, 0.20% or more, 0.30% or more, 0.40% or more, 0.50% or more, or 0.60% or more.

In the present invention, haze values are defined according to JIS K7136. Specifically, the haze values are defined as the ratios of the diffuse transmittance τ_{d} with respect to the total light transmittance τₜ. More specifically, the haze values can be calculated from the following equation:

Haze (%)=[(τ₄/τ₂)−τ₃(τ₂/τ₁)]×100
τ₁: luminous flux of incident light
τ₂: Total luminous flux transmitted through the sample
τ₃: luminous flux diffused by the device
τ₄: luminous flux diffused by the device and the sample

Further, the transparent conductive laminate of the present invention may have, for example, an absolute value of b* value in L*a*b* colorimetric system of 0.80 or less, 0.70 or less, 0.60 or less, 0.50 or less, 0.40 or less, 0.30 or less, 0.20 or less, or 0.10 or less.

In the present disclosure, L* value, a* value, and b* value in L*a*b* colorimetric system are values measured by transmission modes in accordance with JIS Z8722. In the measurement of these values, a standard light D65 specified by the Japanese Industrial Standards 28720 is employed as a light source, and the measurement is performed under the condition of 2 degree field of view.

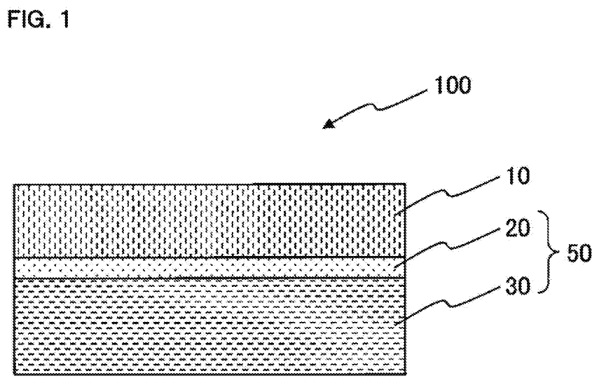

FIG. 1 is a schematic diagram of a transparent conductive laminate of the present invention. As shown in FIG. 1, the transparent conductive laminate 100 of the present invention includes a laminated substrate 50 and a transparent conductive layer 10 laminated on the laminated substrate. The laminated substrate 50 includes a transparent substrate 30 and a cured resin layer 20 laminated on the transparent substrate, and the transparent conductive layer 10 includes a fibrous conductive material having an average fiber diameter of 100 nm or less.

Hereinafter, each component constituting the transparent conductive laminate of the present invention will be described.

### <Laminated Substrate>

The laminated substrate used in the transparent conductive laminate of the present invention has a transparent substrate and a cured resin layer laminated on the transparent substrate. The refractive index of the cured resin layer is smaller than the refractive index of the transparent substrate, whereby reflection on the surface of the cured resin layer can be suppressed.

In addition, the laminated substrate has a top peak of the transmission spectrum and a bottom peak of the reflection spectrum in the range of 385 nm to 485 nm, and does not have a bottom peak of the transmission spectrum and a top peak of the reflection spectrum in the range of 385 nm to 485 nm.

Moreover, in the range of 650 nm to 850 nm, the laminated substrate may have no bottom peak and one or no top peak of the transmission spectrum, and/or may have no top peak and one or no bottom peak of the reflection spectrum. It is also preferred that, in the range of 650 nm to 850 nm, the laminated substrate has no bottom and top peaks of the transmission spectrum and no top and bottom peaks of the reflection spectrum in order to achieve good color tone and transmittance of the transparent conductive laminate having the laminated substrate.

By having such a transmission spectrum and a reflectance spectrum, the laminated substrate may have b* value in L*a*b* chromatic system of −0.40 or less, −0.50 or less, or −0.60 or less, or of −1.00 or more, −0.90 or more, −0.80 or more, or −0.70 or more.

In order for the laminated substrate to have the transmission spectrum and the reflection spectrum as described above, interference between reflection at the surface of the cured resin layer and reflection at the interface between the cured resin layer and the transparent substrate can be generated by the difference between the refractive index of the cured resin layer and the refractive index of the transparent substrate.

Therefore, the difference between the refractive index of the cured resin layer and the refractive index of the transparent substrate may be 0.05 or more, 0.06 or more, 0.07 or more, 0.08 or more, 0.09 or more, or 0.10 or more. The difference may be 0.20 or less, 0.19 or less, 0.18 or less, 0.17 or less, 0.16 or less, or 0.15 or less.

Specifically, since the relationship between the refractive index n1 of the transparent substrate and the refractive index n2 of the cured resin layer on the transparent substrate is n1>n2, the phase of the incident light from the cured resin layer side is shifted by a half wavelength in both the reflection at the surface of the cured resin layer and the reflection at the interface between the cured resin layer and the transparent substrate. Thus, by making the difference in optical path length of these paths approximately n times (n is a positive integer) the wavelength of light between 385 nm and 485 nm, in which the reduction of reflection is intended, the top peak of the transmission spectrum and the bottom peak of the reflection spectrum which are in the range between 385 nm and 485 nm, and the bottom peak of the transmission spectrum and the top peak of the reflection spectrum which are not in the range between 385 nm and 485 nm, can be obtained.

Specifically, in this case, considering a wavelength of 435 nm, which is the approximately middle wavelength between 385 nm and 485 nm, the difference in optical path length may be, for example, 435 nm×n±100 nm, 435 nm×n±70 nm, 435 nm×n±50 nm, or 435 nm×n±30 nm (n is a positive integer, in particular 1 to 10 positive).

### (Transparent Substrate)

The transparent substrate constituting the laminated substrate may be any transparent substrate on which a cured resin layer can be laminated to constitute the laminated substrate. Such a transparent substrate may be an organic material such as polymer or an inorganic material such as glass.

As the transparent substrate, in particular, a polymer substrate can be used. Examples of such polymer substrates include films of polyacrylates, polyolefins, polycarbonates, polyether sulfones, and polyamideimides. As the polyolefin film, a cycloolefin polymer film can be used.

As the polymer substrate, a material of optically low birefringence, a material in which the phase difference, which is the product of birefringence and film thickness, is controlled to about ¼ or ½ of the wavelength of visible light (referred to as “λ/4 film” or “λ/2 film”), or a material in which birefringence is not controlled at all, can be appropriately selected depending on the application. Examples of cases of appropriately selecting according to the application include cases of using the transparent conductive laminate of the present invention as a display member exhibiting a function through polarized light such as linearly polarized light, elliptically polarized light, or circularly polarized light, like a so-called inner type touch panel incorporating a function such as a polarizing plate or a retardation film used for a liquid crystal display or a polarizing plate or a retardation film for preventing reflection of an organic EL display.

The thickness of the transparent substrate can be appropriately determined, but in general, it may be 10 μm or more, 20 μm or more, 30 μm or more, 40 μm or more, or 50 μm or more, and it may be 500 μm or less, 400 μm or less, 300 μm or less, 200 μm or less, or 100 μm or less from the point of view of strength and workability such as handling.

### (Cured Resin Layer)

The cured resin layer constituting the laminated substrate may be any cured resin layer that can be laminated on a transparent substrate to constitute the laminated substrate.

The cured resin layer can be formed of, for example, a curable resin such as a thermosetting resin or a photocurable resin. Examples of the photocurable resin include an ultraviolet curable resin, an electron beam curable resin, and the like.

Materials for forming the cured resin layer include organosilane-based thermosetting resins such as methyltriethoxysilane and phenyltriethoxysilane, melamine-based thermosetting resins such as etherified methylolmelamine, resins formed by using polyol acrylate, polyester acrylate, urethane acrylate as monomers, polyfunctional acrylate-based ultraviolet curable resins such as epoxy acrylate, and the like.

The thickness and the refractive index of the cured resin layer can be adjusted in consideration of the difference in optical path length as described above so as to obtain the reflection spectrum as described above.

In this regard, in order to adjust the refractive index of the cured resin layer, particles having a refractive index different from that of the cured resin constituting the cured resin layer can be dispersed in the cured resin layer.

As such particles, particles selected from the group consisting of metal oxides, metal nitrides, and metal fluorides are suitably used. As the metal oxide particles, it is possible to use at least one selected from the group consisting of Al₂O₃, Bi₂O₃, CaF₂, In₂O₃, In₂O₃·SnO₂, HfO₂, La₂O₃, Sb₂O₅, Sb₂O₅·SnO₂, SiO₂, TiO₂, Y₂O₃, ZnO and ZrO₂, and in particular, it is possible to use at least one selected from the group consisting of Al₂O₃, SiO₂, TiO₂. As the metallic fluoride particles, MgF₂ can be used. In particular, SiO₂, MgF₂, which are capable of lowering the refractive index of the cured resin layer, are preferable.

Particle size of such particles, 1 nm or more, 5 nm or more, or may be 1 nm or more, 100 nm or less, 70 nm or less, may be 50 nm or less. When the particle diameter of the particle is too large, light scattering is liable to occur, which is not preferable. In addition, if the particle diameter is too small, the specific surface area of the particles is increased to accelerate the activation of the particle surface, and the cohesiveness between the particles becomes remarkably high, thereby making it difficult to prepare and store the solution, which is not preferable.

The particle diameter can be obtained as the number average primary particle diameter by directly measuring the diameter of a circle of equal projection area based on the photographed image obtained with scanning electron microscope (SEM), transmission electron microscope (TEM), or the like, and analyzing the particle group of 100 or more.

A liquid phase method, a gas phase method, or the like can be used as a method for producing such particles, but there are no particular restrictions on these production methods.

The compounding ratio of dispersing the particles in the cured resin layer may be 5 parts by mass or more, 10 parts by mass or more, 30 parts by mass or more, 50 parts by mass or more, and may be 500 parts by mass or less, 400 parts by mass or less, 300 parts by mass or less, 200 parts by mass or less, or 100 parts by mass or less, based on 100 parts by mass of the cured resin component. If the amount of particles is too small, the effect of adjusting the refractive index may not be sufficient. If there are too many particles, it may be difficult to uniformly disperse them in the cured resin layer.

The thickness of the cured resin layer may be 50 nm or more, 80 nm or more, and may be 3,000 nm or less, 1,000 nm or less, or 500 nm or less.

The cured resin layer may be added with a coloring material for color tone adjustment. The addition of the coloring material to the cured resin layer may be performed in combination with the adjustment of the film thickness and the refractive index of the cured resin layer, or may be performed alone.

In general, the coloring material includes a dye and a pigment. In consideration of reliability and the like, an inorganic pigment is preferable. By selecting a coloring material, absorption in the specific wavelength region or in the entire region of the visible light region can be imparted, and color tone can be adjusted. The amount of the coloring material may be an amount in which the reduction rate of the transmittance in the wavelength region corresponding to the absorption wavelength of the coloring material is, for example, 0.5% or more, and is 5.0% or less, 3.0% or less, or 1.0% or less, compared with the transmittance before the addition of the coloring material.

However, when a coloring material is used, since the transmittance of the transparent conductive laminate of the present invention is lowered by light absorption by the coloring material, it is preferable that the amount of the coloring material is relatively small or the coloring material is not used, in order to increase the transmittance of the transparent conductive laminate of the present invention.

The cured resin layer can be formed by a coating method. In an actual coating method, the above-mentioned compound is dissolved in various organic solvents, and a coating solution whose concentration and viscosity are adjusted is used to coat a phase difference film, and then the layer is cured by irradiation, heat treatment, or the like. As the coating method, for example, various coating methods such as a microgravure coating method, a meyer bar coating method, a direct gravure coating method, a reverse roll coating method, a curtain coating method, a spray coating method, a comma coating method, a the coating method, a knife coating method, and a spin coating method are used.

The cured resin layer can be laminated on the transparent substrate directly or via an appropriate anchor layer. Examples of such an anchor layer include a layer having a function of improving the adhesion between the cured resin layer and the transparent substrate, a layer having a function of preventing transmission of moisture or air, a layer having a function of absorbing moisture or air, a layer having a function of absorbing ultraviolet rays or infrared rays, and a layer having a function of decreasing the charging property of the transparent substrate.

### (Transparent Conductive Layer)

The transparent conductive layer used in the transparent conductive laminate of the present invention has a fibrous conductive material. The average fiber diameter of the fibrous conductive material may be 100 nm or less, 90 nm or less, 80 nm or less, 70 nm or less, 60 nm or less, 50 nm or less, 40 nm or less, and may be 5 nm or more, 10 nm or more, 20 nm or more, or 30 nm or more. The average fiber length of the fibrous conductive material may be 10 μm or more, 15 μm or more, 20 μm or more, 25 μm or more, 30 μm or more, and may be 100 μm or less, 90 μm or less, 80 μm or less, 70 μm or less, 60 μm or less, or 50 μm or less.

In the present invention, the average fiber diameter can be obtained as the number average fiber diameter by directly measuring the fiber diameter of each individual fiber based on a photographed image by observation with a scanning electron microscope (SEM), transmission electron microscope (TEM), or the like, and analyzing the fiber group of 100 or more.

The surface resistance value of the transparent conductive layer may be, for example, 1,000 Ω/square or less, 500 Ω/square or less, 300 Ω/square or less, 200 Ω/square or less, or 100 Ω/square or less, and may be 1 Ω/square or more, 10 Ω/square or more, 20 Ω/square or more, or 30 Ω/square or more. In order to lower the surface resistance value, it is preferable to increase the amount of the fibrous conductive material or to appropriately increase the average fiber length.

Specifically, the fibrous conductive material may be a metal wire such as a silver nanowire, or a fibrous conductive material such as a carbon nanotube. Such fibrous conductive materials, in particular metal nanowires, and more particularly silver nanowires, are preferred in that the bending resistance required in bendable displays that will be realized in the future is superior to transparent conductive layers obtained using conductive metal oxides such as ITO. It is also known that such a fibrous conductive material is excellent in other properties such as optical properties and conductivity.

When a transparent conductive film is obtained using a fibrous conductive material, a wet process such as a spraying method or a coating method can be used.

When a fibrous conductive material is used as the material of the transparent conductive layer, it is preferable to further use a resin material as a binder for bonding and fixing the fibrous conductive material to each other. As the resin material, a thermoplastic resin or a curable resin may be used, and the curable resin may be a curable resin that is cured by heat, light, electron beam, or radiation. These may be used alone or in combination it is particularly preferable to use an ultraviolet curable resin as the resin material.

When a fibrous conductive material is used as the material of the transparent conductive layer, it is preferable to further use an additive for preventing deterioration of metal of the fibrous conductive material by light or heat, and for example, an ultraviolet absorbing material, an antioxidant, or the like can be used.

### (Overcoat)

When a fibrous conductive material is used, the fibrous conductive material can be coated with another material having a different refractive index to reduce the reflectance, in order to suppress the emulsification and white turbidity caused by the fibrous conductive material reflecting and scattering light from the outside. The material for such a coating can be selected so as not to impair the conductivity of the fibrous conductive material.

In addition, a coloring material can be added to the overcoat to adjust the color tone of the transparent conductive layer. Regarding the use of the coloring material, reference can be made to the description of the cured resin layer described above.

If a fibrous conductive material is used as the material of the transparent conductive layer, an overcoat can be provided on the layer of fibrous conductive material after the layer has been formed. The overcoat may be provided to impregnate the layer of fibrous conductive material and cure such that a portion of the fibrous conductive material is exposed from the surface, thereby increasing the strength of the transparent conductive layer while maintaining a low surface resistance of the transparent conductive layer.

As the overcoat in the present invention, a cured resin layer described later can be used.

The overcoat in the present invention may be made of a thermosetting resin, an ultraviolet (UV) curable resin, an electron beam (EB) curable resin, or the like. In applications where the surface resistance at the overcoat surface is allowed to be relatively high, such as electromagnetic wave shielding materials, these overcoats may be applied.

In an application in which the surface resistance value on the overcoat surface is preferably low, it is preferable to apply an overcoat formed from at least one product produced through condensation reaction after hydrolyzing at least one compound selected from the group consisting of a metal alkoxide and a metal acetoxide.

The thickness of the overcoat may be, for example, 10 nm or more, 20 nm or more, 30 nm or more, 40 nm or more, 50 nm or more, and may be 150 nm or less, 140 nm or less, 130 nm or less, 120 nm or less, 110 nm or less, or 100 nm or less, from the viewpoint of excellent coating strength and solvent resistance.

If the thickness of the overcoat is too thin, sufficient coating strength cannot be obtained, which may be disadvantageous in a post-processing step, and solvent resistance tends to be low. On the other hand, if the overcoat is too thick, the surface resistance tends to increase.

### EXAMPLES

Hereinafter, the present invention will be described in detail with reference to examples, but the present invention is not limited to these examples.

### Reference Example 1, Examples 1-2, and Comparative Examples 1-27

In the following Reference Examples 1, Examples 1-2, and Comparative Examples 1-2, a cycloolefin polymer films (made by Zeon, Japan, ZF14) were used as transparent substrates, and, on the transparent substrate, a transparent conductive layer was formed directly (Reference Example 1) or via a cured resin layer (Examples 1-2. and Comparative Examples 1-2) by using a dispersion solution of silver nanowire, in order to obtain transparent conductive laminates.

Specifically, transparent conductive laminates of Reference Example 1, Examples 1 to 2, and Comparative Examples 1 to 2 were obtained as follows.

### Reference Example 1

A dispersion of silver nanowires was applied directly onto a cycloolefin polymer (COP) film as a transparent substrate to form a transparent conductive layer having a surface resistance of 50 Ω/□. Silver nanowires having average fiber diameter of 25 nm and average fiber length of 40 pm were used, water (ion-exchanged water) was used as a dispersion medium, and the solid content concentration of the dispersion was 0.2 wt %.

The optical properties of the transparent substrate and the optical properties of the transparent conductive laminate obtained by forming the transparent conductive layer on the transparent substrate are shown in Table 1 below.

### Example 1

### (Formation of Laminated Substrate)

A curing resin coating solution was obtained by mixing a urethane acrylate-based ultraviolet curable resin (manufactured by Arakawa Chemical Co., Ltd., beam-set 575, cured film refractive index 1.51) and a MgF₂ nanoparticle dispersion (manufactured by UK Nanotech Co., Ltd.) so that the solid content mass ratio was 100:300, and diluting the mixture with an organic solvent (1-methoxy-2-propanol) to a solid content concentration of 10 wt %. The UV-curable resins had a refractive index of 1.49 and MgF₂ nanoparticles had a refractive index of 1.39.

Thereafter, the obtained curing resin coating solution was coated on the same transparent substrate as in Reference Example 1, dried, and cured by ultraviolet irradiation to obtain a laminated substrate having a cured resin layer on the transparent substrate.

### (Formation of a Transparent Conductive Laminate)

A transparent conductive layer was formed by applying a dispersion of silver nanowires on the cured resin layer of the formed laminated substrate in the same manner as in Reference Example 1, thereby obtaining a transparent conductive laminate having a transparent conductive layer on the laminated substrate.

### (Optical Properties)

The optical properties of the laminated substrate and the transparent conductive laminate obtained as described above are shown in Table 1 below.

### Example 2

### (Formation of Laminated Substrate)

A laminated substrate having a cured resin layer on a transparent substrate was obtained in the same manner as in Example 1 except that the thickness of the cured resin layer formed on the transparent substrate was changed.

### (Formation of a Transparent Conductive Laminate)

A transparent conductive layer was formed by applying a dispersion of silver nanowires on the cured resin layer of the formed substrate laminate in the same manner as in Reference Example 1, thereby obtaining a transparent conductive laminate having a transparent conductive layer on the laminated substrate.

### (Optical Properties)

The optical properties of the laminated substrate and the transparent conductive laminate obtained as described above are shown in Table 1 below.

### Comparative Example 1

### (Formation of Laminated Substrate)

A laminated substrate having a cured resin layer on a transparent substrate was obtained in the same manner as in Example 1 except that, in the preparation of the curing resin coating solution, the mass ratio of the solid content between the urethane acrylate-based UV-curable resin and MgF₂ nanoparticle dispersion was changed from 100:300 to 100:100 and the thickness of the cured resin layer was changed.

### (Formation of a Transparent Conductive Laminate)

A transparent conductive layer was formed by applying a dispersion of silver nanowires on the cured resin layer of the formed substrate laminate in the same manner as in Reference Example 1, thereby obtaining a transparent conductive laminate having a transparent conductive layer on the laminated substrate.

### (Optical Properties)

The optical properties of the laminated substrate and the transparent conductive laminate obtained as described above are shown in Table 1 below.

### Comparative Example 2

### (Formation of Laminated Substrate)

A laminated substrate having a cured resin layer on a transparent substrate was obtained in the same manner as in Comparative Example 1 except that the thickness of the cured resin layer formed on the transparent substrate was changed.

### (Formation of Transparent Conductive Laminate)

A transparent conductive layer was formed by applying a dispersion of silver nanowires on the cured resin layer of the formed substrate laminate in the same manner as in Reference Example 1, thereby obtaining a transparent conductive laminate having a transparent conductive layer on the laminated substrate.

### (Optical Properties)

The optical properties of the laminated substrate and the transparent conductive laminate obtained as described above are shown in Table 1 below.

The measurement of the transmission spectrum and the reflection spectrum is performed under the following conditions: Measurements were carried out with the measurement wavelength range of 340 to 850 nm, scan speed of 600 nm/min, sampling interval of 1 nm; for reflection spectrum, 5° incident angle on the sample and the integrating sphere measurement mode were used; for transmission spectrum, normal incidence on the sample and the integrating sphere measurement mode were used.

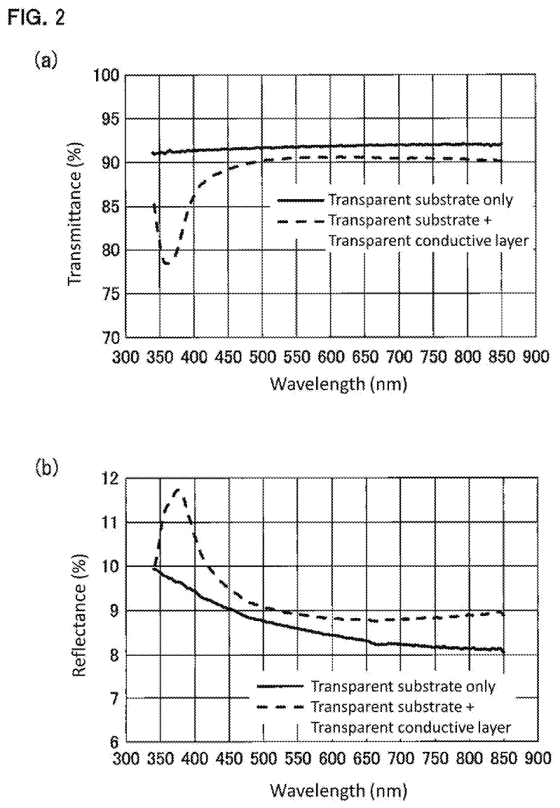

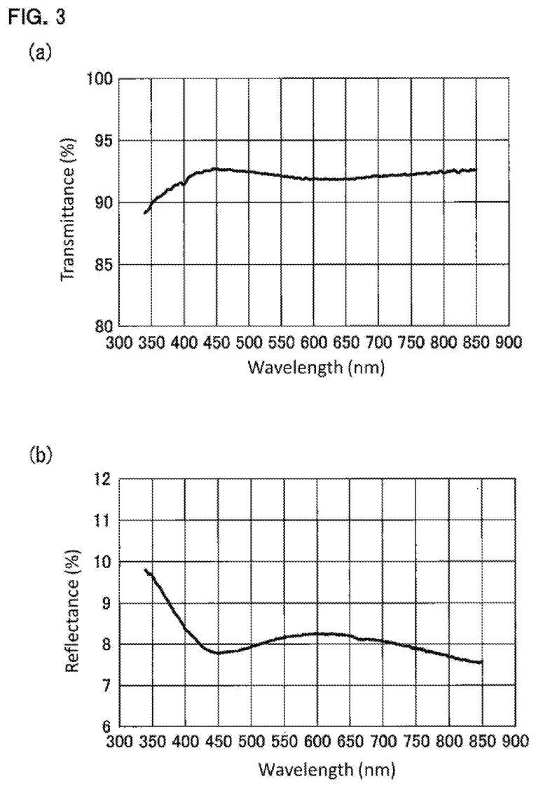

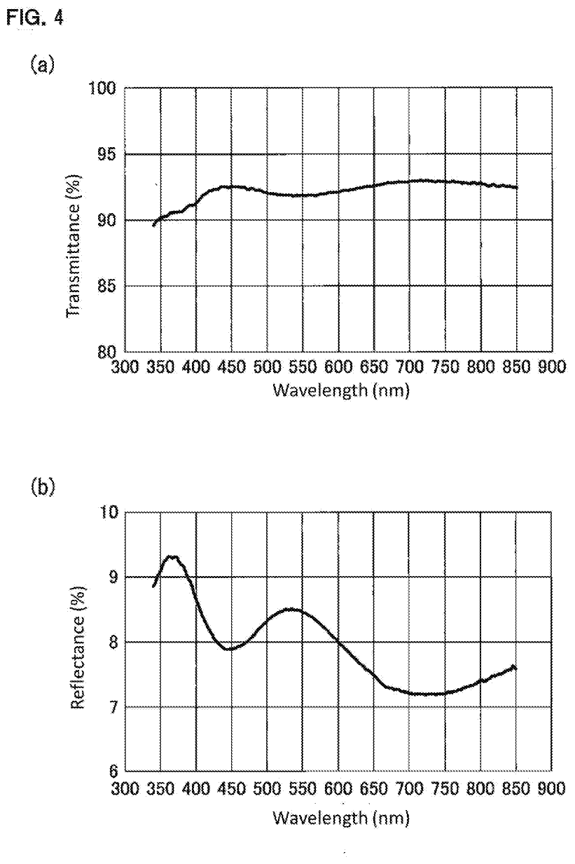

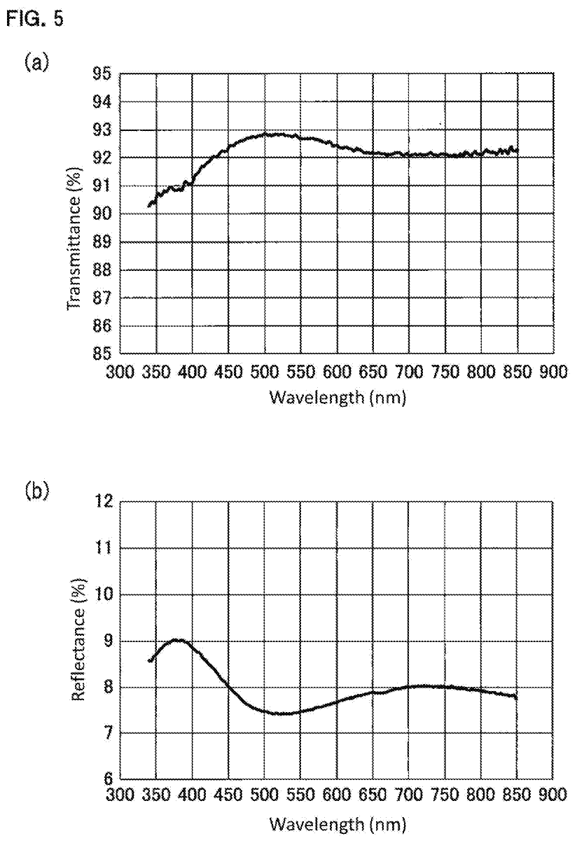

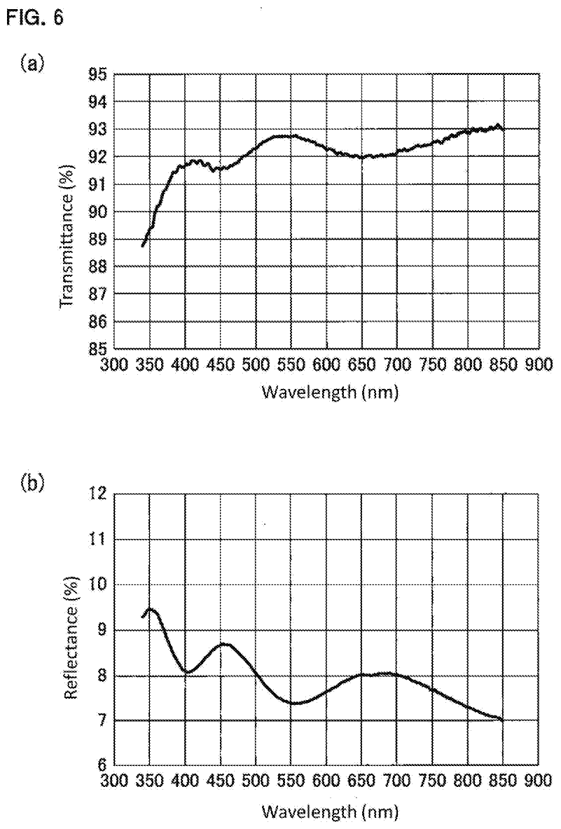

TABLE 1

| | | REFERENCE EXAMPLE 1 | | | | | |
|---|---|---|---|---|---|---|---|
| | | Transparent | Transparent | EXAMPLE 1 | | EXAMPLE 2 | |
| | | substrate | substrate with | | Transparent | | Transparent |
| | | (laminated | transparent | Laminated | conductive | Laminated | conductive |
| | | substrate) | conductive layer | substrate | laminate | substrate | laminate |
| Transparent | Type | COP | | COP | | COP | |
| substrate | Refractive index (n1) | 1.51 | | 1.51 | | 1.51 | |
| Cured resin | Binder (mass ratio) | — | | UV curable resin | | UV curable resin | |
| layer | | | | (100) | | (100) | |
| | Nanoparticle | — | | MgF₂ | | MgF₂ | |
| | (mass ratio) | | | (300) | | (300) | |
| | Refractive index (n2) | | | 1.40 | | 1.40 | |
| | Thickness | — | | 220 nm | | 380 nm | |
| Transparent | Resistance | — | 50 Ω/□ | — | 50 Ω/□ | — | 50 Ω/□ |
| conductive layer | | | | | | | |
| Refractive index difrerence (n1 − n2) | | — | | 0.11 | | 0.11 | |
| Peak of | Transmission top | None | | Yes (450 nm) | | Yes (459 nm) | |
| laminated | Transmission bottom | None | | None | | None | |
| substrate in | Reflection top | None | | None | | None | |
| 385 to 485 nm | Reflection bottom | None | | Yes (450 nm) | | Yes (446 nm) | |
| Optical properties | Total light transmittance | 92.4 | 91.7 | 93.0 | 92.2 | 93.0 | 92.8 |
| of the transparent | Haze | 0.03 | 0.66 | 0.03 | 0.61 | 0.03 | 0.65 |
| conductive laminate | L′ | 96.7 | 96.1 | 96.8 | 96.0 | 96.9 | 96.1 |
| | a′ | 0.02 | −0.44 | −0.06 | −0.23 | 0.60 | −0.65 |
| | b′ | 0.12 | 0.99 | −0.67 | 0.21 | −0.45 | 0.41 |
| | Spectrum | FIG. 2 | FIG. 2 | FIG. 3 | — | FIG. 4 | — |

| | | Comparative Example 1 | | Comparative Example 2 | |
|---|---|---|---|---|---|
| | | | Transparent | | Transparent |
| | | Laminated | conductive | Laminated | conductive |
| | | substrate | laminate | substrate | laminate |
| Transparent | Type | COP | | COP | |
| substrate | Refractive index (n1) | 1.51 | | 1.51 | |
| Cured resin | Binder (mass ratio) | UV curable resin | | UV curable resin | |
| layer | | (100) | | (100) | |
| | Nanoparticle | MgF₂ | | MgF₂ | |
| | (mass ratio) | (100) | | (100) | |
| | Refractive index (n2) | 1.45 | | 1.45 | |
| | Thickness | 270 nm | | 480 nm | |
| Transparent | Resistance | — | 50 Ω/□ | — | 50 Ω/□ |
| conductive layer | | | | | |
| Refractive index difrerence (n1 − n2) | | 0.06 | | 0.06 | |
| Peak of | Transmission top | None | | Yes (411 nm) | |
| laminated | Transmission bottom | None | | Yes (439 nm) | |
| substrate in | Reflection top | None | | Yes (454 nm) | |
| 385 to 485 nm | Reflection bottom | None | | Yes (404 nm) | |
| Optical properties | Total light transmittance | 93.2 | 92.1 | 93.2 | 91.5 |
| of the transparent | Haze | 0.04 | 0.68 | 0.04 | 0.69 |
| conductive laminate | L′ | 96.7 | 96.2 | 97.0 | 95.2 |
| | a′ | −0.35 | −0.55 | −0.49 | −0.44 |
| | b′ | 0.31 | 1.22 | 0.47 | 1.07 |
| | Spectrum | FIG. 5 | — | FIG. 6 | — |

In the table, “transmission top” refers to the top peak in the transmission spectrum, “transmission bottom” refers to the bottom peak in the transmission spectrum, “reflection top” refers to the top peak in the reflection spectrum, and “reflection bottom” refers to the bottom peak in the reflection spectrum.

### <Analysis of Evaluation Results>

### Reference Example 1

The cycloolefin polymer film as the transparent substrate of Reference Example 1 was almost colorless and transparent. This corresponds to the fact that the absolute value of b* value of the transparent substrate of Reference Example 1 is small in Table 1, and that the transmission spectrum and the reflectance spectrum of the “transparent substrate only” change only smoothly in FIG. 2 for Reference Example 1.

On the other hand, as in Reference Example 1, the transparent conductive laminate, which was obtained by forming a transparent conductive layer composed of silver nanowires on the transparent substrate, had a yellowish color. This corresponds to the fact that, in Table 1, b* value of the transparent conductive laminate of Reference Example 1 is a relatively large positive value, and that, in FIG. 2 for Reference Example 1, the bottom peak of the transmission spectrum and the top peak of the reflection spectrum of the “transparent substrate+transparent conductive layer” exist in the range of 350 nm to less than 385 nm.

### Examples 1 and 2

The laminated substrates of Examples 1 and 2 had a top peak of transmission spectrum and a bottom peak of reflection spectrum in the range of 385 nm to 485 nm, and did not have a bottom peak of transmission spectrum and a top peak of reflection spectrum in the range of 385 nm to 485 nm. In addition, in the laminated substrates of Examples 1 and 2, the refractive index of the cured resin layer was smaller than that of the transparent substrate.

The transparent conductive laminates of Examples 1 and 2 were substantially colorless and transparent. This corresponds to the lower absolute value of b* value of the transparent conductive laminates of Examples 1 and 2 as shown in Table 1.

### Comparative Example 1

In the laminated substrate of Comparative Example 1, although the refractive index of the cured resin layer was smaller than the refractive index of the transparent substrate, the top peak and the bottom peak of the transmission spectrum as well as the top peak and the bottom peak of the reflection spectrum did not exist in the range of 385 nm to 485 nm.

The transparent conductive laminate of Comparative Example 1 had a yellowish color. This corresponds to the fact that b* value of the transparent conductive laminate of Comparative Example 1 is a relatively large positive value in Table 1.

### Comparative Example 2

The laminated substrate of Comparative Example 2 had all of the top peak and the bottom peak of the transmission spectrum and the top peak and the bottom peak of the reflection spectrum in the range of 385 nm to 485 nm, although the refractive index of the cured resin layer was smaller than the refractive index of the transparent substrate.

The transparent conductive laminate of Comparative Example 2 had a yellowish color. This corresponds to the fact that b* value of the transparent conductive laminate of Comparative Example 2 is a relatively large positive value in Table 1.

### Reference Example 2, Examples 3-6, and Comparative Examples 3-4

In the following Reference Example 2, Examples 3 to 6, and Comparative Examples 3 to 4, polycarbonate films (Teijin Corporation. Pure Ace C110-100) were used as transparent substrates, and, on this transparent substrate, a transparent conductive layer was formed directly without a cured resin layer (Reference Example 2), or via cured resin layers (Examples 3 to 6, and Comparative Examples 3 to 4) using a silver nanowire dispersion, in order to obtain transparent conductive laminates.

Specifically, transparent conductive laminates of Reference Example 2, Examples 3 to 6, and Comparative Examples 3 to 4 were obtained as follows.

### Reference Example 2

A dispersion of silver nanowires was applied directly onto a polycarbonate (PC) film as a transparent substrate in the same manner as in Reference Example 1 to form a transparent conductive layer having a surface resistance value of 50 Ω/□.

The optical properties of the transparent substrate and the optical properties of the transparent conductive laminate obtained by forming the transparent conductive layer on the transparent substrate are shown in Table 2 below.

### Example 3

### (Formation of Laminated Substrate)

A curing resin coating solution was obtained by mixing a urethane acrylate-based ultraviolet curable resin (manufactured by Arakawa Chemical Co., Ltd., beam set 575, cured film refractive index 1.51) and a MgF₂ nanoparticle dispersion (manufactured by CIK Nanotech Co., Ltd.) so that the solid content was 100:200, and diluting the mixture with an organic solvent (1-methoxy-2-propanol) to a solid content of 15 wt %. The UV-curable resins had a refractive index of 1.49 and MgF₂ nanoparticles had a refractive index of 1.39.

Thereafter, the obtained curing resin coating solution was coated on the same transparent substrate as in Reference Example 2, dried, and cured by ultraviolet irradiation to obtain a laminated substrate having a cured resin layer on the transparent substrate.

### (Formation of a Transparent Conductive Laminate)

A transparent conductive layer was formed by applying a dispersion of silver nanowires on the cured resin layer of the formed laminated substrate in the same manner as in Reference Example 2, thereby obtaining a transparent conductive laminate having a transparent conductive layer on the laminated substrate.

### (Optical Properties)

The optical properties of the laminated substrate and the transparent conductive laminate obtained as described above are shown in Table 2 below.

### Example 4

### (Formation of Laminated Substrate)

A laminated substrate having a cured resin layer on a transparent substrate was obtained in the same manner as in Example 3 except that, in the preparation of the curing resin coating solution, the weight ratio of the solid content between the urethane acrylate-based UV-curable resin and MgF₂ nanoparticle dispersion was changed from 100:200 to 100:100 and the thickness of the cured resin layer was changed.

### (Formation of a Transparent Conductive Laminate)

A transparent conductive layer was formed by applying a dispersion of silver nanowires on the cured resin layer of the formed laminated substrate in the same manner as in Reference Example 2, thereby obtaining a transparent conductive laminate haying a transparent conductive layer on the laminated substrate.

### (Formation of Overcoat)

An overcoat having a thickness of 80 nm was applied to the formed transparent conductive layer to impregnate the silver nanowires constituting the transparent conductive layer, thereby obtaining a transparent conductive laminate having a transparent conductive layer with an overcoat on the laminated substrate. Incidentally, the overcoat was formed by using an overcoat application solution in which an acrylic-based ultraviolet-curable resin (manufactured by Shin-Nakamura Chemical Co., Ltd., A-DHP) was diluted with an organic solvent (a mixture of 1-methoxy-2-propanol and diacetone alcohol in a volume ratio of 2:1) to obtain a solid content of 2.0 wt %.

### (Optical Properties)

The optical properties of the laminated substrate and the transparent conductive laminate obtained as described above are shown in Table 2 below.

### Example 5

### (Formation of Laminated Substrate)

A laminated substrate having a cured resin layer on a transparent substrate was obtained in the same manner as in Example 3 except that, in the preparation of the curing resin coating solution, the weight ratio of the solid content between the urethane acrylate-based UV-curable resin and MgF₂ nanoparticle dispersion was changed from 100:200 to 100:50.

### (Formation of a Transparent Conductive Laminate)

A transparent conductive layer was formed by applying a dispersion of silver nanowires on the cured resin layer of the formed laminated substrate in the same manner as in Reference Example 2, thereby obtaining a transparent conductive laminate having a transparent conductive layer on the laminated substrate.

### (Formation of Overcoat)

An overcoat was applied to the formed transparent conductive layer in the same manner as in Example 4 to obtain a transparent conductive laminate having a transparent conductive layer with an overcoat on the laminated substrate.

### (Optical Properties)

The optical properties of the laminated substrate and the transparent conductive laminate obtained as described above are shown in Table 2 below.

### Example 6

### (Formation of Laminated Substrate)

A laminated substrate having a cured resin layer on a transparent substrate was obtained in the same manner as in Example 3 except that, in the preparation of the curing resin coating solution, the weight ratio of the solid content between the urethane acrylate-based UV-curable resin and MgF₂ nanoparticle dispersion was changed from 100:200 to 100:10 and the thickness of the cured resin layer was changed.

### (Formation of a Transparent Conductive Laminate)

A transparent conductive layer was formed by applying a dispersion of silver nanowires on the cured resin layer of the formed laminated substrate in the same manner as in Reference Example 2, thereby obtaining a transparent conductive laminate having a transparent conductive layer on the laminated substrate.

### (Formation of Overcoat)

An overcoat was applied to the formed transparent conductive layer in the same manner as in Example 4 to obtain a transparent conductive laminate having a transparent conductive layer with an overcoat on the laminated substrate.

### (Optical Properties)

The optical properties of the laminated substrate and the transparent conductive laminate obtained as described above are shown in Table 2 below.

### Example 7

A transparent conductive laminate was obtained in the same manner as in Example 4 except that the thickness of cured resin layers was as shown in the table, cured resin layers were formed on both sides of the transparent substrate, transparent conductive layers were formed on both cured resin layers, and overcoats were applied to both transparent conductive layers.

### Comparative Example 3

### (Formation of Laminated Substrate)

A laminated substrate having a cured resin layer on a transparent substrate was obtained in the same manner as in Example 4 except that the thickness of the cured resin layer formed on the transparent substrate was changed.

### (Formation of a Transparent Conductive Laminate)

A transparent conductive layer was formed by applying a dispersion of silver nanowires on the cured resin layer of the formed laminated substrate in the same manner as in Reference Example 2, thereby obtaining a transparent conductive laminate having a transparent conductive layer on the laminated substrate.

### (Optical Properties)

The optical properties of the laminated substrate and the transparent conductive laminate obtained as described above are shown in Table 2 below.

### Comparative Example 4

### (Formation of Laminated Substrate)

A laminated substrate having a cured resin layer on a transparent substrate was obtained in the same manner as in Example 4 except that, in the preparation of the curing resin coating solution, a TiO₂ nanoparticle dispersion (manufactured by CIK Nanotech) was used instead of MgF₂ nanoparticle dispersion and the thickness of the cured resin layer was changed. The refractive index of TiO₂ nanoparticles was 2.55.

### (Formation of Transparent Conductive Laminate)

A transparent conductive layer was formed by applying a dispersion of silver nanowires on the cured resin layer of the formed laminated substrate in the same manner as in Reference Example 2, thereby obtaining a transparent conductive laminate haying a transparent conductive layer on the laminated substrate.

### (Optical Properties)

The optical properties of the laminated substrate and the transparent conductive laminate obtained as described above are shown in Table 2 below.

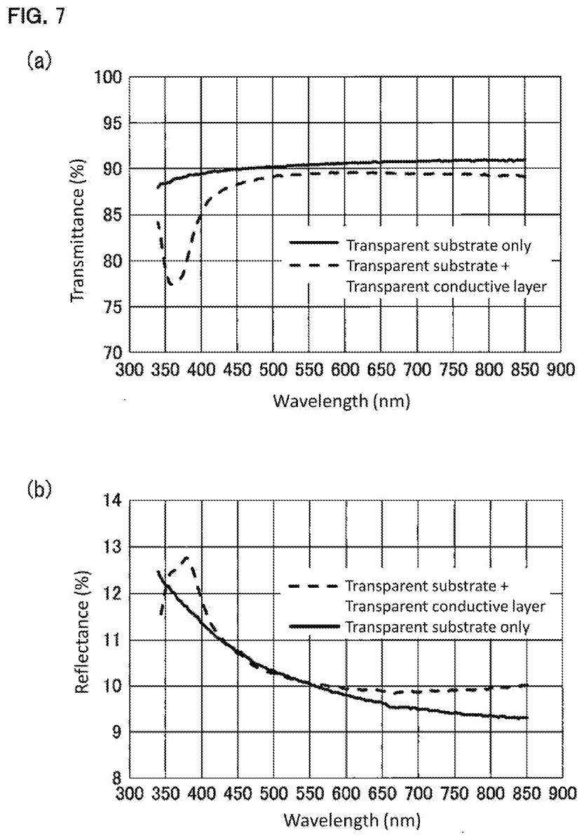

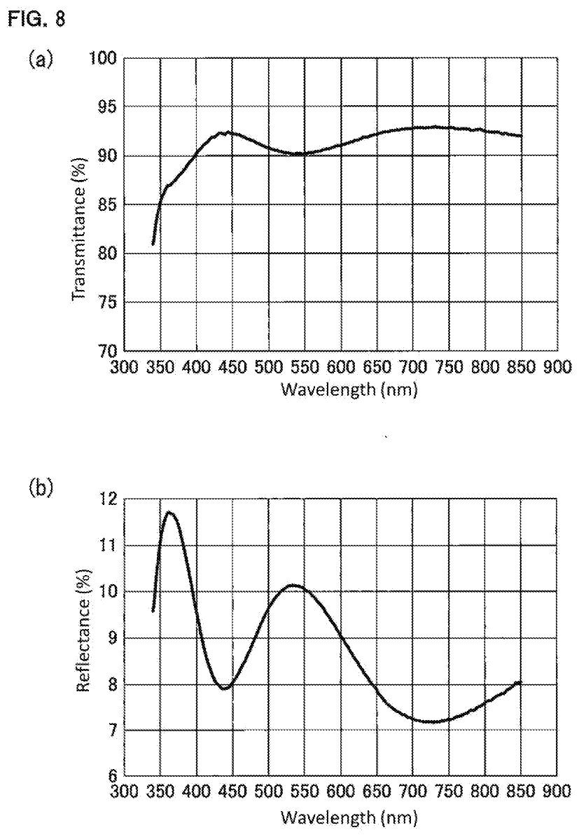

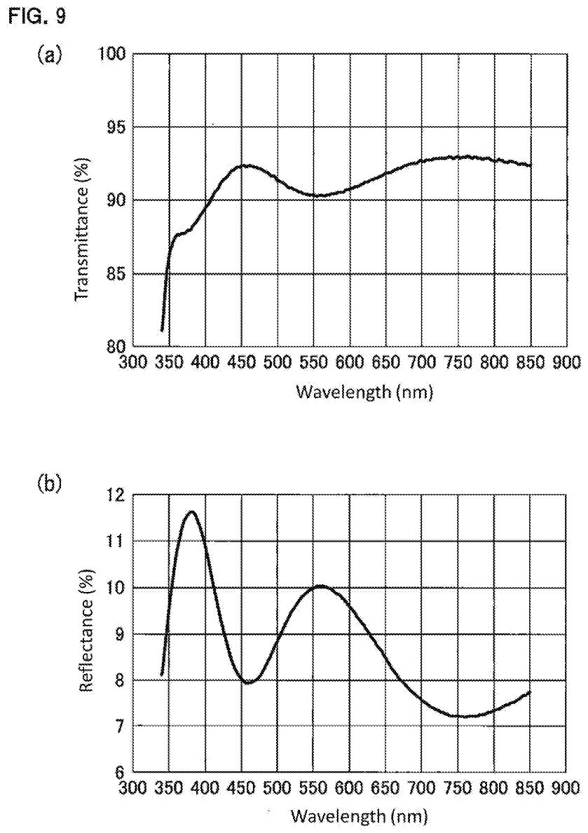

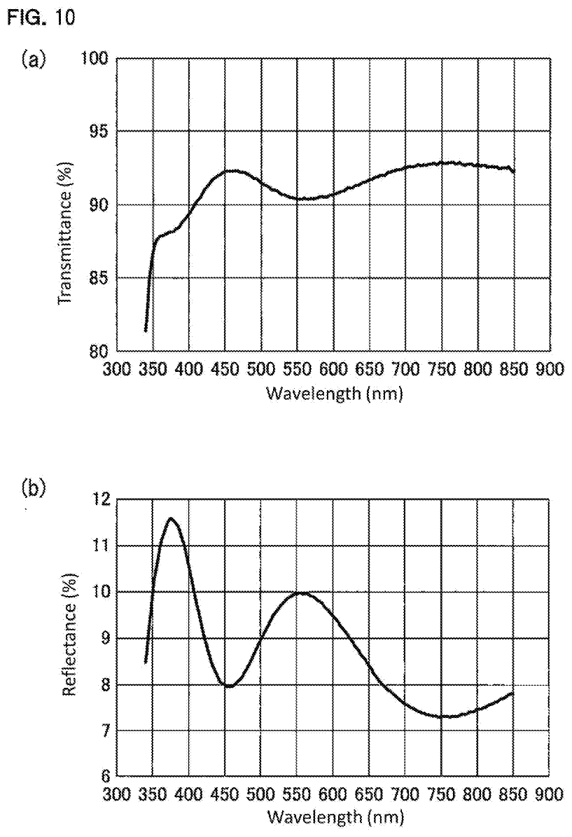

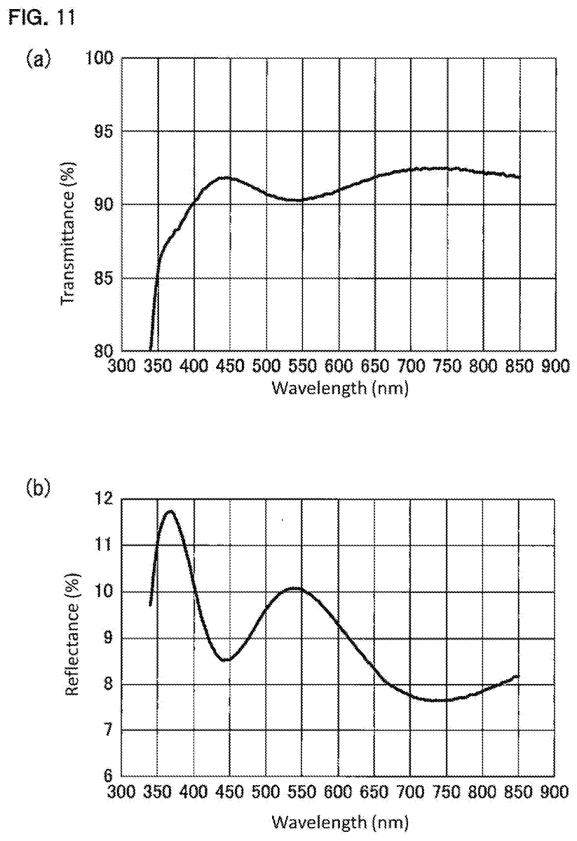

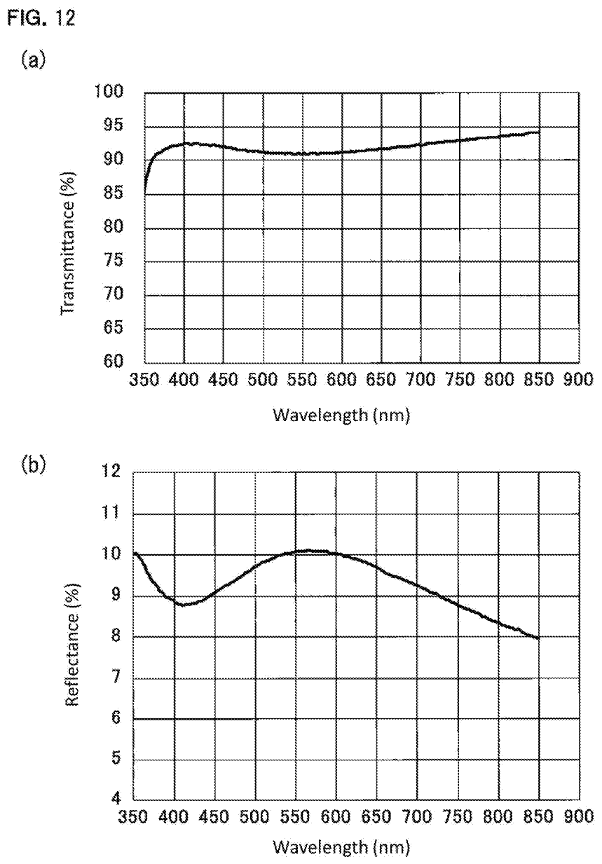

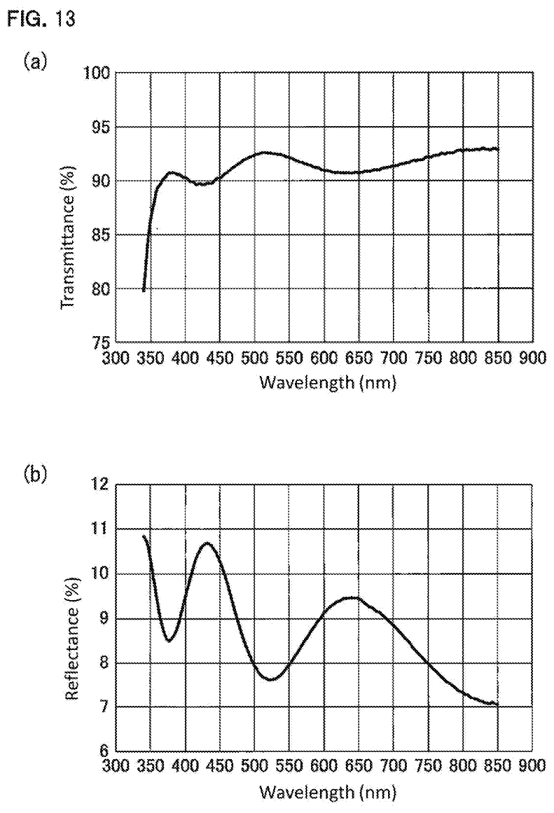

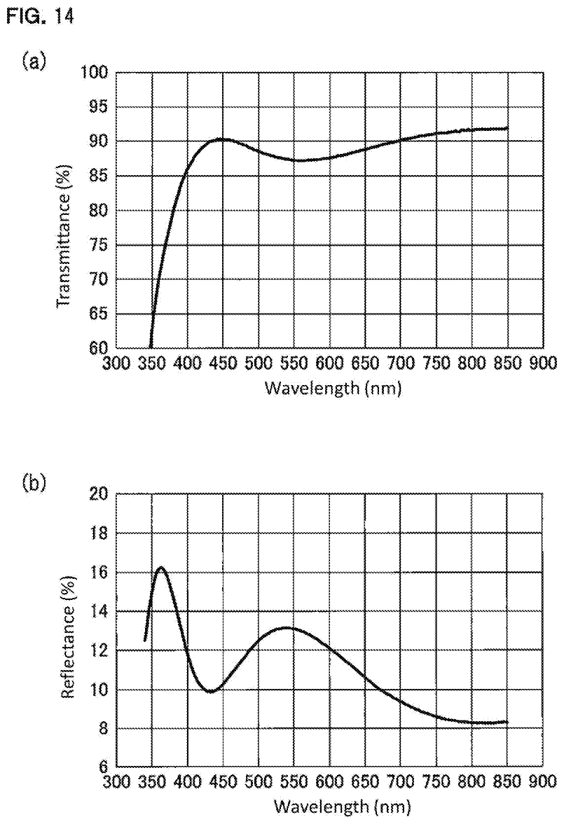

TABLE 2

| | | REFERENCE EXAMPLE 2 | | | | |
|---|---|---|---|---|---|---|
| | | Transparent | Transparent | EXAMPLE 3 | | |
| | | substrate | substrate with | | Transparent | EXAMPLE 4 |
| | | (Laminated | transparent | Laminated | conductive | Laminated |
| | | substrate) | conductive layer | substrate | laminate | substrate |
| Transparent | Type | PC | | PC | | PC |
| substrate | Refractive index (n1) | 1.56 | | 1.56 | | 1.56 |
| Cured resin | Binder (mass ratio) | — | | UV curable resin | | UV curable resin |
| layer | | | | (100) | | (100) |
| | Nanoparticle | — | | MgF₂ | | MgF₂ |
| | (mass ratio) | | | (200) | | (100) |
| | Refractive index (n2) | | | 1.42 | | 1.45 |
| | Thickness | — | | 380 nm | | 990 nm |
| Transparent | Resistance | — | 50 Ω/□ | — | 50 Ω/□ | — |
| conductive layer | Overcoat | — | — | — | — | — |
| Refractive index difference (n1 − n2) | | — | | 0.14 | | 0.11 |
| Peak of | Transmission top | None | | Yes (444 nm) | | Yes (461 nm) |
| laminated | Transmission bottom | None | | None | | None |
| substrate in | Reflection top | None | | None | | None |
| 385~485 nm | Reflection bottom | None | | Yes (438 nm) | | Yes (458 nm) |
| Optical properties | Total light transmittance | 91.0 | 90.0 | 91.7 | 90.5 | 91.6 |
| of the transparent | Haze | 0.03 | 0.65 | 0.09 | 0.64 | 0.08 |
| conductive laminate | L′ | 96.2 | 95.5 | 96.5 | 95.7 | 96.3 |
| | a′ | −0.08 | −0.39 | 0.00 | 0.32 | 0.50 |
| | b′ | 0.36 | 1.04 | −0.75 | −0.30 | −0.77 |
| | Spectrum | FIG. 7 | FIG. 7 | FIG. 8 | — | FIG. 9 |

| | | EXAMPLE 4 | | EXAMPLE 5 | | |
|---|---|---|---|---|---|---|
| | | Transparent | Transparent | | Transparent | Transparent |
| | | conductive | conductive | Laminated | conductive | conductive |
| | | laminate | laminate | substrate | laminate | laminate |
| Transparent | Type | PC | | PC | | |
| substrate | Refractive index (n1) | 1.56 | | 1.56 | | |
| Cured resin | Binder (mass ratio) | UV curable resin | | UV curable resin | | |
| layer | | (100) | | (100) | | |
| | Nanoparticle | MgF₂ | | MgF₂ | | |
| | (mass ratio) | (100) | | (50) | | |
| | Refractive index (n2) | 1.45 | | 1.47 | | |
| | Thickness | 390 nm | | 380 nm | | |
| Transparent | Resistance | 50 Ω/□ | 50 Ω/□ | — | 50 Ω/□ | 50 Ω/□ |
| conductive layer | Overcoat | — | Present | — | — | Present |
| Refractive index difference (n1 − n2) | | 0.11 | | 0.09 | | |
| Peak of | Transmission top | Yes (461 nm) | | Yes (467 nm) | | |
| laminated | Transmission bottom | None | | None | | |
| substrate in | Reflection top | None | | None | | |
| 385~485 nm | Reflection bottom | Yes (458 nm) | | Yes (456 nm) | | |
| Optical properties | Total light transmittance | 90.7 | 90.6 | 91.7 | 90.9 | 90.7 |
| of the transparent | Haze | 0.68 | 0.66 | 0.07 | 0.65 | 0.67 |
| conductive laminate | L′ | 95.6 | 95.6 | 96.3 | 95.7 | 95.6 |
| | a′ | 0.30 | 0.04 | 0.50 | −0.28 | −0.20 |
| | b′ | 0.01 | 0.21 | −0.80 | 0.21 | 0.38 |
| | Spectrum | — | — | FIG. 10 | — | — |

| | | | | | EXAMPLE 7 | | | | | |
|---|---|---|---|---|---|---|---|---|---|---|
| | | EXAMPLE 6 | | | | Transparent | Comparative Example 3 | | Comparative Example 4 | |
| | | | Transparent | Transparent | Laminated | conductive | | Transparent | | Transparent |
| | | Laminated | conductive | conductive | substrate | laminate | Laminated | conductive | Laminated | conductive |
| | | substrate | laminate | laminate | (both sides) | (both sides) | substrate | laminate | substrate | laminate |
| Transparent | Type | PC | | | PC | | PC | | PC | |
| substrate | Refractive | 1.56 | | | 1.56 | | 1.56 | | 1.56 | |
| | index (n1) | | | | | | | | | |
| Cured resin | Binder | UV curable resin | | | UV curable resin | | UV curable resin | | UV curable resin | |
| layer | (mass ratio) | (100) | | | (100) | | (100) | | (100) | |
| | Nanoparticle | MgF₂ | | | MgF₂ | | MgF₂ | | TiO₂ | |
| | (mass ratio) | (10) | | | (100) | | (100) | | (100) | |
| | Refractive | 1.5 | | | 1.45 | | 1.45 | | 2.01 | |
| | index (n2) | | | | | | | | | |
| | Thickness | 360 nm | | | 450 nm | | 450 nm | | 210 nm | |
| Transparent | Resistance | — | 50 Ω/□ | 50 Ω/□ | — | 50 Ω/□ | — | 50 Ω/□ | — | 50 Ω/□ |
| conductive | Overcoat | — | — | Present | — | Present | — | — | — | — |
| layer | | | | | | | | | | |
| Refractive index | | 0.06 | | | 0.11 | | 0.11 | | −0.45 | |
| difference (n1 − n2) | | | | | | | | | | |
| Peak of | Transmission | Yes (445 nm) | | | Yes (403 nm) | | None | | Yes (445 nm) | |
| laminated | top | | | | | | | | | |
| substrate in | Transmission | None | | | None | | Yes (425 nm) | | None | |
| 385~485 nm | bottom | | | | | | | | | |
| | Reflection | None | | | None | | Yes (432 nm) | | None | |
| | top | | | | | | | | | |
| | Reflection | Yes (442 nm) | | | Yes (386 nm) | | None | | Yes (433 nm) | |
| | bottom | | | | | | | | | |
| Optical | Total light | 91.6 | 90.7 | 90.9 | 90.7 | 88.9 | 92.4 | 91.3 | 88.8 | 89.0 |
| properties | transmittance | | | | | | | | | |
| of the | Haze | 0.07 | 0.65 | 0.67 | 0.06 | 1.05 | 0.08 | 0.68 | 0.04 | 0.63 |
| transparent | L′ | 96.3 | 95.6 | 95.7 | 96.6 | 95.4 | 96.8 | 96.1 | 95.0 | 94.9 |
| conductive | a′ | 0.52 | 0.05 | −0.60 | 0.19 | −0.96 | −1.23 | −1.37 | 0.76 | 0.70 |
| laminate | b′ | −0.57 | 0.09 | 0.56 | −0.69 | 1.36 | 0.84 | 1.47 | −1.24 | −1.15 |
| | Spectrum | FIG. 11 | — | — | FIG. 12 | — | FIG. 13 | — | FIG. 14 | — |

### <Analysis of Evaluation Results>

### Reference Example 2

The polycarbonate film as the transparent substrate of Reference Example 2 was almost colorless and transparent. This corresponds to the fact that the absolute value of b* value of the transparent substrate of Reference Example 2 is small in Table 2, and that the transmission spectrum and the reflectance spectrum of the “transparent substrate only” are changed only smoothly in FIG. 7 for Reference Example 2.

On the other hand, as in Reference Example 2, the transparent conductive laminate, which was obtained by forming a transparent conductive layer composed of silver nanowires on the transparent substrate, had a yellowish color. This corresponds to the fact that, in Table 2, b* value of the transparent conductive laminate of Reference Example 2 is a relatively large positive value, and that, in FIG. 7 for Reference Example 2, the bottom peak of the transmission spectrum and the top peak of the reflection spectrum of the “transparent substrate ±transparent conductive layer” exist in the range of 350 nm to less than 385 nm.

### Examples 3-6

The laminated substrates of Examples 3 to 6 had a top peak of transmission spectrum and a bottom peak of reflection spectrum in the range of 385 nm to 485 nm, and did not have a bottom peak of transmission spectrum and a top peak of reflection spectrum in the range of 385 nm to 485 nm. In the laminated substrates of Examples 3 to 6, the refractive index of the cured resin layer was smaller than that of the transparent substrate.

The transparent conductive laminates of Examples 3 to 6 were substantially colorless and transparent. This corresponds to the lower absolute value of b* value of the transparent conductive laminates of Examples 3 to 6 in Table 2. n addition, the transparent conductive laminate of Example 7, despite having the cured resin layer, the transparent conductive layer, and the overcoat on both sides of the transparent substrate, had lower b* values than the transparent conductive laminate of Comparative Example 3, which had the cured resin layer and the transparent conductive layer on one side of the transparent substrate. Consequently, in the transparent conductive layer of Example 7, the yellow color was smaller.

### Comparative Example 3

In the laminated substrate of Comparative Example 3, although the refractive index of the cured resin layer was smaller than that of the transparent substrate, the top peak of the transmission spectrum and the bottom peak of the reflection spectrum were not in the range of 385 nm to 485 nm, and the bottom peak of the transmission spectrum and the top peak of the reflection spectrum were in the range of 385 nm to 485 nm.

The transparent conductive laminate of Comparative Example 3 had a yellowish color. This corresponds to the fact that b* value of the transparent conductive laminate of Comparative Example 3 is a relatively large positive value in Table 2.

### Comparative Example 4

The laminated substrate of Comparative Example 2 had the top peak of the transmission spectrum and the bottom peak of the reflection spectrum in the range of 385 nm to 485 nm, and did not have the bottom peak of the transmission spectrum and the top peak of the reflection spectrum in the range of 385 nm to 485 nm. However, in the laminated substrates of Examples 3 to 6, the refractive index of the cured resin layer was higher than that of the transparent substrate.

The transparent conductive laminate of Comparative Example 4 had a bluish color. This corresponds to the fact that a* value and b* value of the transparent conductive laminate of Comparative Example 4 are relatively large negative values in Table 2.

### REFERENCE SIGNS LIST

10 Transparent conductive layer

20 Cured resin layer

30 Transparent substrate

50 Laminated substrate

100 Transparent conductive laminate of the present invention

1. A transparent conductive laminate comprising a laminated substrate and a transparent conductive layer laminated on the laminated substrate, wherein
the laminated substrate comprises a transparent substrate and a cured resin layer laminated on the transparent substrate,
the laminated substrate has a top peak of transmission spectrum and a bottom peak of reflection spectrum in a range of 385 nm to 485 nm,
the laminated substrate does not have a bottom peak of transmission spectrum and a top peak of reflection spectrum in a range of 385 nm to 485 nm,
the transparent conductive layer comprises a fibrous conductive material, and
the refractive index of the cured resin layer is smaller than the refractive index of the transparent substrate.

2. The transparent conductive laminate according to claim 1, wherein the refractive index of the cured resin layer and the refractive index of the transparent substrate are different from each other by 0.05 or more.

3. The transparent conductive laminate according to claim 1, wherein the cured resin layer is formed of a cured resin and particles dispersed in the cured resin.

4. The transparent conductive laminate according to claim 3, wherein the particles are selected from the group consisting of metal oxides, metal nitrides, and metal fluorides.

5. The transparent conductive laminate according to claim 1, wherein, in the range of 650 nm to 850 nm,
the laminated substrate does not have a bottom peak of transmission spectrum, and does not have a top peak of transmission spectrum or has one top peak of transmission spectrum, and/or
the laminated substrate does not have a top peak of reflection spectrum, and does not have a bottom peak of reflection spectrum or has one bottom peak of reflection spectrum.

6. The transparent conductive laminate according to claim 1, wherein b* value in L*a*b* colorimetric system of the laminated substrate is −0.40 or less.

7. The transparent conductive laminate according to claim 1, wherein the fibrous conductive material is a silver wire.

8. The transparent conductive laminate according to claim 1, wherein the total light transmittance is 90% or more.

9. The transparent conductive laminate according to claim 1, wherein the haze value is 1.00% or less.

10. The transparent conductive laminate according to claim 1, wherein the absolute value of b* value in L*a*b* colorimetric system is 0.80 or less.
